(19) United States
(12) Patent Application Publication
(10) Pub. No.: US 2003/0105819 A1
(43) Pub. Date: Jun. 5, 2003

(54) Web collaborative browsing system and method using internet relay chat protocol

(76) Inventors: Ji Yong Kim, Taejon (KR); Jeong Hwa Yang, Taejon (KR); Doo Hyun Kim, Taejon (KR); Eun Ryung Lee, Taejon (KR); Yon Hee Kim, Taejon (KR)

Correspondence Address: JACOBSON, PRICE, HOLMAN & STERN, PROFESSIONAL LIMITED LIABILITY COMPANY, 400 Seventh Street. N.W., Washington, DC, 20004, US

(21) Appl. No.: 10/066,749

(22) Filed: Feb. 6, 2002

(30) Foreign Application Priority Data
Dec. 5, 2001 (KR) 2001-76441

(51) Int. Cl. G06F 15/16

(52) U.S. Cl. 709/205

(57) ABSTRACT

A Web collaborative browsing system and method using an Internet relay chat (IRC) protocol. A plurality of users can view a Web page of the same address, or uniform resource locator (URL), at the same time through Web browsers run in a plurality of terminals. The users act as clients to an IRC server by means of collaborative browsing client programs installed in the Web browsers. On the basis of these component programs, the users can each construct a desired session or join a pre-constructed session to share the same Web page with other users in the same session. Each of the collaborative browsing client programs is executed in the corresponding Web browser to act to receive an event from the Web browser, create a message corresponding to the received event and send the created message, and to receive a message from the IRC server, analyze the received message and apply a command based on the analysis result to the Web browser. Therefore, using an existing standard IRC server, synchronization can be established among browsers of a plurality of users in one session.

### BACKGROUND OF THE INVENTION

1. Field of the Invention

The present invention relates to a Web collaborative browsing system and method using an Internet relay chat (IRC) protocol, and more particularly to a Web collaborative browsing system and method using an IRC protocol, wherein Web browsers run in a plurality of remote user terminals can share a Web page, or HTML (Hyper Text Markup Language) page, with one another. The invention relates particularly to a Web collaborative browsing system and method wherein an event occurring in a Web browser of a specific remote user terminal is sent as a control message to a counterpart terminal and then executed in a Web browser of the counterpart terminal through a series of processes, thereby establishing synchronization between the Web browsers.

2. Description of the Related Art

It is well known that users are able to search Web sites for desired information over the Internet. The information search by the users is a basic method for detecting information from the Web sites.

In detail, a user requests a Web site through his/her Web browser to search for desired information. In response to the search request, a Web server of the Web site searches for the desired information, converts the search result into a Web page format, or HTML format, and sends the converted result to the Web browser.

This model has various unique features, one of which is a hyper text link contained in the detected Web page. This link is means enabling the information searching user to gain access (surf) from one Web page to another Web page.

However, it is very hard for a nonexpert to accurately search for desired information over the Internet having copious information scattered thereon, so he/she will obtain help from an expert to search for the desired information. In order for a remote expert to provide a service to nonexperts in an Internet environment, there is a need for a mechanism to synchronize Web page accesses among Web browsers run in a plurality of user terminals.

A screen sharing method using an image transfer technique may be a representative mechanism for synchronization of Web page accesses.

The screen sharing method serves to copy (or compress) a remote application image directly and send the copied image over a communication channel.

The copied image is sent to and processed in a terminal of a remote user in which an application is actually executed.

The above-mentioned screen sharing method can desirably be applied to all various applications and establish a perfect synchronization, but has a disadvantage in that it is inefficient in the current Internet environment because image data is not small in size.

Another screen sharing method is to share a screen on Web browsers by detecting an event in a Web browser area of a specific terminal from a message queue of an operating system of the specific terminal, sending the detected event as a message to a remote counterpart terminal, storing the sent message in a message queue of an operating system of the counterpart terminal and processing the stored message like a message inputted by an input unit of the counterpart terminal.

The above screen sharing method is efficient in terms of only a control message (or event list) of a small size being sent, but disadvantageous in that it must be programmed at a low level, i.e., an operating system level and implemented with different mechanisms with respect to respective actual operating systems.

Another screen sharing method is a method using a proxy server. In this method, once a proxy server is constructed, a Web browser always fetches a Web document (HTML document) via the proxy server. Upon receiving an HTTP (Hyper Text Transfer Protocol)-based request from a client browser, a collaborative browsing server replacing the proxy server sends related information to a different client terminal in the same group so as to provide an inter-browser screen match.

However, the above screen sharing method also requires a separate communication channel for synchronization of events other than a Web page address.

Yet another screen sharing method is to provide a screen match by designing and developing a collaborative browsing server to share control information using a separate inter-client communication channel and protocol. This method is desirable to convert a variety of events occurring in a browser into control information and transfer/process the converted control information, in a different manner from the proxy server-based method, but has a disadvantage of necessitating the development of a separate server.

Accordingly, there is a need for the development of a method capable of synchronizing Web page searches more reliably.

### SUMMARY OF THE INVENTION

Therefore, the present invention has been made in view of the above problems, and it is an object of the present invention to provide a Web collaborative browsing system and method using an IRC protocol, wherein a client program, which is a component program in a standard browser, acts as an IRC client to gain access to a standard IRC server so as to send to the server an address of a Web page to be searched by a plurality of users in the same group, thereby allowing a centralized server to search for the Web page, modify the contents thereof and send the resulting Web page to a requesting Web browser.

It is another object of the present invention to provide a Web collaborative browsing system and method using an IRC protocol, wherein a standard IRC server is used, resulting in no additional work being required for implementation of a collaborative browsing server, a verified standard protocol is used to transfer a control message and a chatting message together, resulting in a stability in message transfer, and a component program is inserted in a browser so that it can be simply installed and used by a user.

In accordance with one aspect of the present invention, the above and other objects can be accomplished by the provision of a Web collaborative browsing method using an Internet relay chat (IRC) protocol and a standard IRC server, comprising the steps of a), by a collaborative browsing client, opening a collaborative browsing session; b), by the collaborative browsing client, creating a control message corresponding to an event if the event occurs while the client is connected to a Web server to conduct Web surfing, after the collaborative browsing session is opened, and then sending the created control message to the IRC server over a network; c), by the IRC server, receiving the sent event occurrence control message and transferring the received control message to a plurality of clients participating in the collaborative browsing session opened by the collaborative browsing client; and d), by a collaborative browsing component program of each of the session participating clients, instructing a Web browser of a corresponding one of the session participating clients in response to the control message to request the same event as that having occurred in the collaborative browsing client, from the Web server.

Preferably, the step b) may include the steps of b-1) detecting the event if it occurs in a Web browser of the collaborative browsing client while the collaborative browsing client is connected to the Web server via the Web browser thereof to conduct the Web surfing; b-2) analyzing the contents of the detected event; b-3) creating the control message corresponding to the analyzed event contents; and b-4) sending the created control message to the IRC server over the network. Here, the network may be a wired or wireless network.

Preferably, the step d) may include the steps of d-1) receiving the control message from the IRC server; d-2) analyzing the received control message to determine a type of the event having occurred in the collaborative browsing client; and d-3) applying a command based on the determination result to the Web browser of the corresponding session participating client to instruct it to request the same event as that having occurred in the collaborative browsing client, from the Web server.

The collaborative browsing component program may be implemented with at least one of Java applet and ActiveX.

The event may include at least one of a Web document request event, a Web page scroll event, a mouse event and a keyboard event.

In accordance with another aspect of the present invention, there is provided a Web collaborative browsing system using an Internet relay chat (IRC) protocol and a standard IRC server, comprising event occurrence processing means for creating a control message corresponding to a type of an event if the event occurs in a Web browser of a collaborative browsing client while the client is connected to a Web server via the Web browser to conduct Web surfing, and then sending the created control message to the IRC server according to the IRC protocol; and event synchronization means for receiving the control message via the IRC server and instructing a corresponding Web browser in response to the received control message to request the same event as that having occurred in the collaborative browsing client, from the Web server.

Preferably, the event occurrence processing means may include an event occurrence detector for detecting the event if it occurs in the Web browser of the collaborative browsing client while the client is connected to the Web server via the Web browser thereof to conduct the Web surfing; an event analyzer for analyzing the contents of the detected event to determine the type of the event; and a message sender for creating the control message corresponding to the analyzed event contents and sending the created control message to the IRC server according to the IRC protocol.

The event synchronization means may include a message receiver for receiving the control message from the IRC server; a message analyzer for analyzing the received control message to determine the type of the event having occurred in the collaborative browsing client; and an event requester for applying a command based on the determination result to the corresponding Web browser to instruct it to request the same event as that having occurred in the collaborative browsing client, from the Web server.

In accordance with yet another aspect of the present invention, there is provided a digital processor-readable storage medium for storing a program typically composed of commands executable by a digital processor to perform a Web collaborative browsing method using a standard Internet relay chat (IRC) protocol, the program being configured to perform the steps of a), by a collaborative browsing client, opening a collaborative browsing session; b), by the collaborative browsing client, creating a control message corresponding to an event if the event occurs while the client is connected to a Web server to conduct Web surfing, after the collaborative browsing session is opened, and then sending the created control message to an IRC server over a network; c), by the IRC server, receiving the sent event occurrence control message and transferring the received control message to a plurality of clients participating in the collaborative browsing session opened by the collaborative browsing client; and d), by a collaborative browsing component program of each of the session participating clients, instructing a Web browser of a corresponding one of the session participating clients in response to the control message to request the same event as that having occurred in the collaborative browsing client, from the Web server.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing a general network connection between users and a Web server;

FIG. 2 is a view schematically showing a network construction of a Web collaborative browsing system using an IRC protocol in accordance with the present invention;

FIG. 3 is a block diagram showing a network connection between a user system and a Web server system in accordance with the present invention;

FIGS. 4A and 4B are block diagrams showing a network connection between a user system and an IRC server system in accordance with the present invention; and

FIG. 5 is a flow chart illustrating an IRC protocol-based Web collaborative browsing method in accordance with the present invention.

### DESCRIPTION OF THE PREFERRED EMBODIMENTS

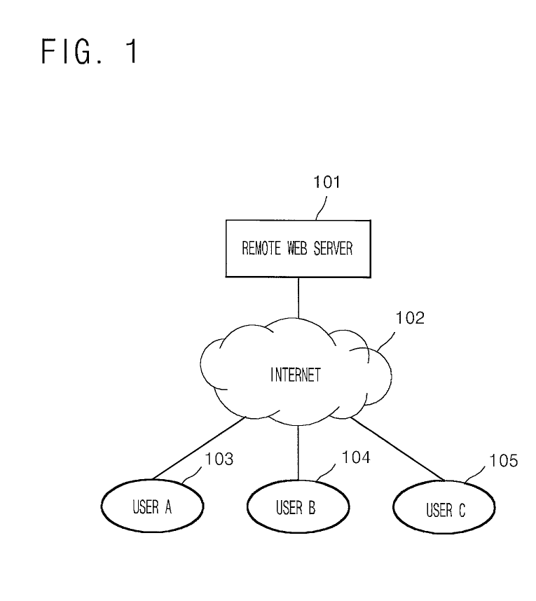

FIG. 1 shows a general network connection between users and a Web server.

As shown in FIG. 1, in a general Internet environment, a plurality of users 103, 104 and 105 can search for Web documents by gaining access to a remote Web server 101 while conducting Web surfing on the Internet 102. However, the user A 103 and the user B 104 are completely unaware of each other, and so cannot share information to render and receive help to/from each other.

Provided that the user A 103 desires to share information of high quality searched via access to the Web server 101, with the user B 104, he/she will have to use other communication means such as a telephone. In order to overcome this problem, the present invention employs a collaborative browsing technique capable of allowing a plurality of users to share a Web document with one another so as to view the same screen at the same time.

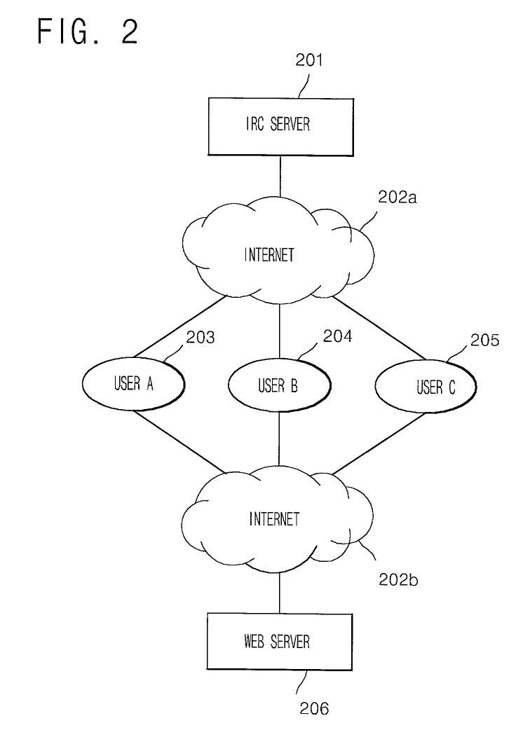

FIG. 2 schematically shows a network construction of a Web collaborative browsing system using an IRC protocol in accordance with the present invention. The construction of FIG. 2 is substantially the same as that of FIG. 1, with the exception that a plurality of users 203, 204 and 205 gain access to an IRC server 201 via an Internet network 202a in a similar manner to that by which they gain access to a Web server 206 via another Internet network 202b. That is, there is present a transfer channel through which the remote users 203, 204 and 205 are able to transfer various control information to one another over the Internet network 202a.

This communication channel is connected between a component program of each of the remote users 203, 204 and 205 and the IRC server 201, and is based on the IRC protocol, which is a standard Internet protocol.

In this regard, the IRC server 201 may be any one of a large number of existing standard IRC servers.

The component program acts as a chatting client, and is capable of being implemented with ActiveX or Java language and executed in a browser. This component program functions to monitor the browser operation, convert the monitored result into a promised control message and transfer the converted control message to the IRC server 201. As a result, the control message can be transferred to all the remote users 203, 204 and 205 in the same group.

The operation of the Web collaborative browsing system with the above-stated construction in accordance with the present invention will hereinafter be described while being classified into the access to the Web server 206 via the Internet network 202b by the plurality of users 203, 204 and 205 and the access to the IRC server 201 via the different Internet network 202a by the plurality of users 203, 204 and 205.

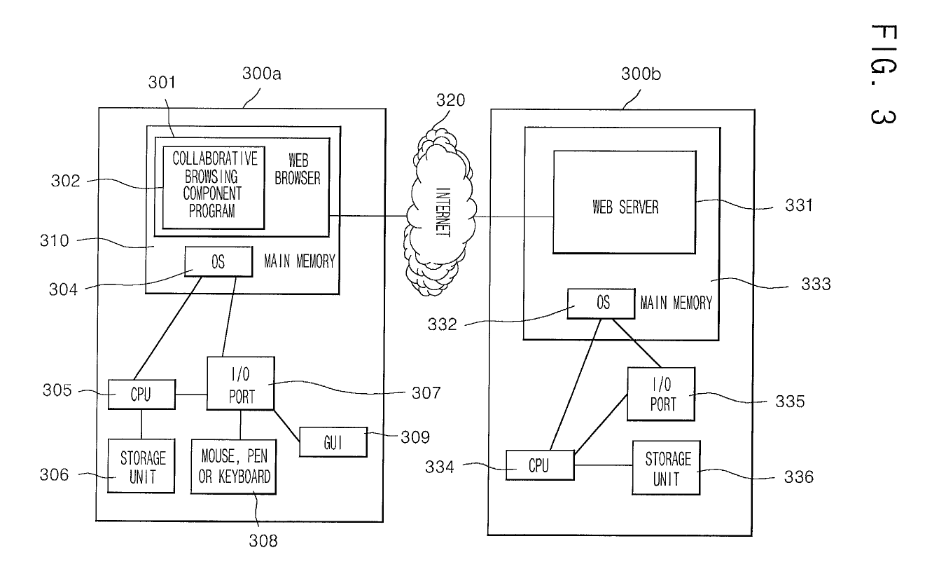

FIG. 3 is a block diagram showing a network connection between a user system and a Web server system in accordance with the present invention, wherein the reference numeral 300a denotes the user system, or collaborative browsing client terminal, and 300b denotes the Web server system.

The collaborative browsing client 300a is a computer that includes a central processing unit (CPU) 305, a storage unit 306, such as a hard disk, a main memory 310, and an input/output (I/O) interface 307.

The I/O interface 307 receives data from an input unit 308, such as a mouse, keyboard or pen, and transfers the received data to the CPU 305 and an operating system (OS) 304 so that it can be processed by them.

The I/O interface 307 also functions to operate a graphic user interface (GUI) 309 on the client.

A Web browser 301 equipped with a collaborative browsing component program 302 is run in the collaborative browsing client 300a. The collaborative browsing component program 302 is connected to a Web server 331 in the Web server system 300b via the Web browser 301 to, upon occurrence of an event during Web surfing, generate a control message related to the event and send it to an IRC server. Upon receiving the event control message sent from the component program 302, the IRC server sends associated Web page information to a plurality of clients (users) connected thereto, so that the information can be shared by the clients.

The Web server system 300b is a computer that includes a CPU 334, a storage unit 336, such as a hard disk, and an I/O interface 335. This system 300b is a general standard Web server system.

The Web server system 300b and the collaborative browsing client 300a are interconnected via an Internet network 320 on the basis of the HTTP.

Consequently, the collaborative browsing client 300a is connected to the Web server system 300b via the Web browser 301 to, upon occurrence of an event in the Web browser 301 during Web surfing, create a control message related to the event according to the collaborative browsing component program 302 in the browser 301 and send it to the IRC server over the Internet.

Upon receiving the event control message, the IRC server sends it to all users (clients) connected thereto. As a result, all events are synchronized among Web browsers run in a plurality of remote user terminals such that users can collaboratively view the same Web page.

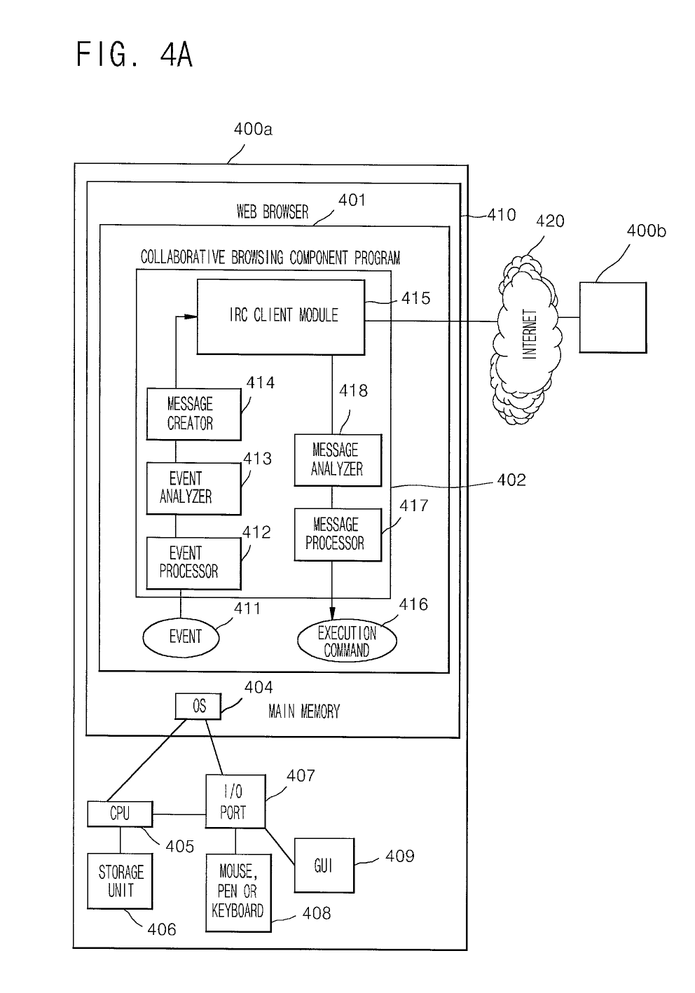

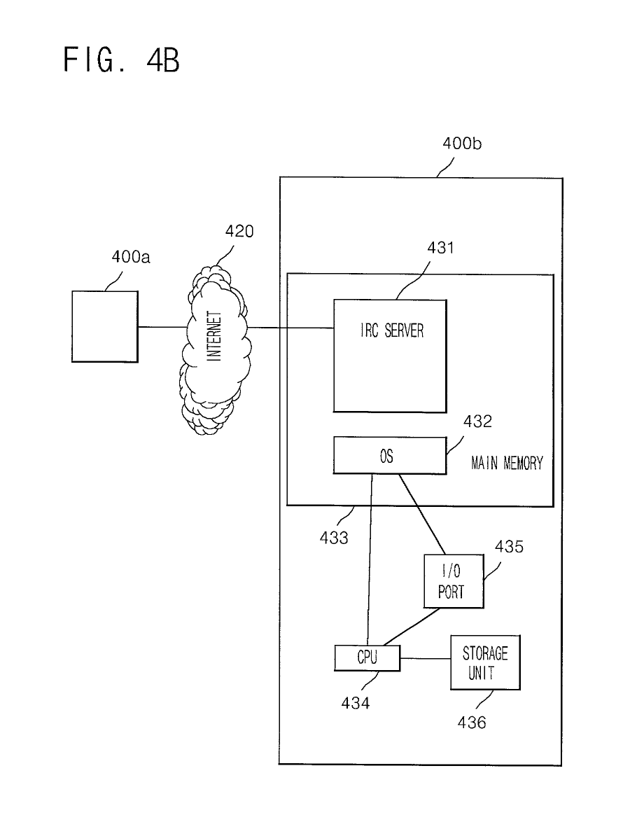

A more detailed description will hereinafter be given of the Web browsing sharing operation based on the collaborative browsing component program with reference to FIGS. 4A and 4B.

FIGS. 4A and 4B are block diagrams showing a network connection between a user system and an IRC server system in accordance with the present invention. Some parts in this drawing are the same in construction as those in FIG. 3 and a description thereof will thus be omitted.

In FIGS. 4A and 4B, the reference numeral 400a denotes the user system, or collaborative browsing client terminal, and 400b denotes the IRC server system.

The collaborative browsing client 400a includes a collaborative browsing component program 402 implemented with Java applet or ActiveX and executed in the below manner.

When an event 411 occurs in a Web browser 401 while the collaborative browsing client 400a is connected to the Web server as shown in FIG. 3 via the browser 401 to conduct Web surfing, an event processor 412 receives a signal corresponding to the event 411, and an event analyzer 413 analyzes the contents of the event 411 and provides the analyzed contents to a message creator 414.

The message creator 414 creates a control message corresponding to the event contents from the event analyzer 413 and provides the created control message to an IRC client module 415.

The IRC client module 415 sends the control message created by the message creator 414 to an IRC server 431 in the IRC server system 400b over an Internet network 420.

The IRC server 431 receives the event occurrence control message sent from the IRC client module 415 in the collaborative browsing client 400a over the Internet network 420 and then transfers the received control message to all users (clients) participating in one session. In practice, the IRC client module 415 of each user receives the control message.

Upon receiving the event occurrence control message sent from the IRC server 431, the IRC client module 415 of each client provides the received control message to a message analyzer 418 in the collaborative browsing component program 402.

The message analyzer 418 analyzes the received control message to determine the type of the event having occurred, and then provides the resulting analysis information to a message processor 417.

On the basis of the analysis information from the message analyzer 418, the message processor 417 applies a command associated with the analyzed event contents to the Web browser.

Accordingly, all events are synchronized among the Web browsers run in the plurality of remote user terminals.

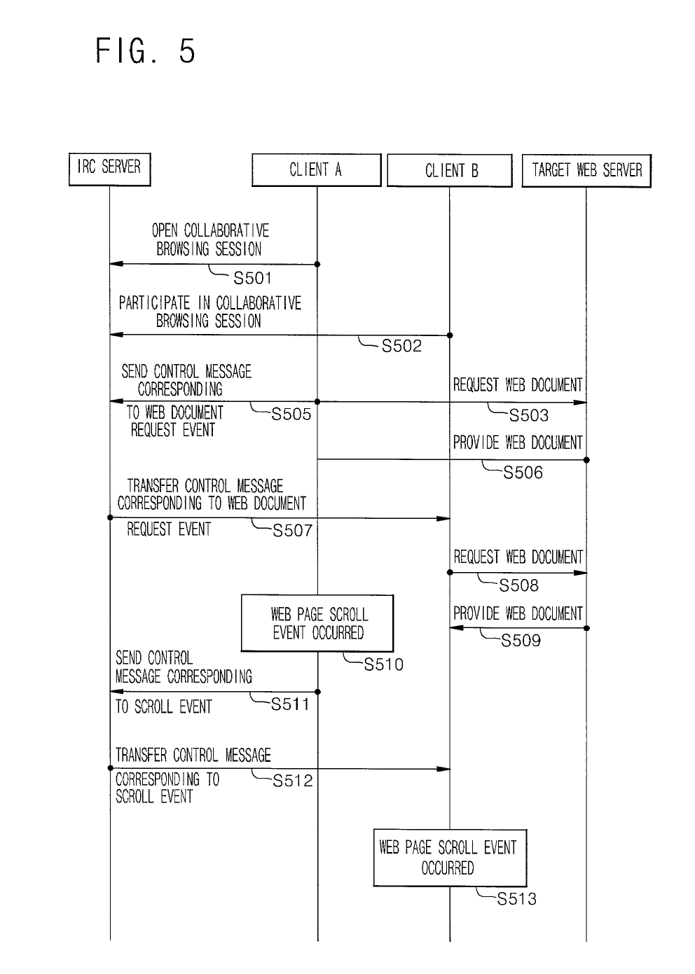

Next, a description will be given of an IRC protocol-based Web collaborative browsing method executed by the above-stated Web collaborative browsing system in accordance with the present invention with reference to FIG. 5.

FIG. 5 is a flow chart illustrating the Web collaborative browsing method using the IRC protocol in accordance with the present invention. Note that only the sharing of a Web page between a client A and a client B will be described in the present embodiment for illustrative purposes, although several users may actually share the Web page with one another.

First, the client A opens a collaborative browsing session to an IRC server as if opening a chatting room (S501).

Of course, this procedure will be performed through a collaborative browsing component program run in a Web browser of the client A.

If the client A opens the session to the IRC server as mentioned above, then the client B participates in the session opened by the client A among opened sessions (S502).

Subsequently, the Web page sharing is attained in the following manner. Namely, if an event related to Web surfing occurs while the client A is connected to a Web server to conduct the Web surfing, that is, if the client A requests an arbitrary Web document of the Web server while surfing on the Web server (S503), a control message corresponding to the Web document request event is sent to the IRC server (S505) whereas the Web server provides the requested Web document to the client A (S506).

In more detail, if an event requesting a Web document from the Web server occurs while the client A is connected to the Web server to conduct Web surfing, the event processor 412 shown in FIG. 4A receives a signal corresponding to the event, and the event analyzer 413 analyzes the contents of the event and provides the analyzed contents to the message creator 414.

The message creator 414 creates a control message corresponding to the event contents from the event analyzer 413 and sends the created control message to the IRC server through the IRC client module 415.

The IRC server receives the Web document request control message sent from the client A and then transfers the received control message to the client B participating in the session opened by the client A (S507).

In response to the control message transferred from the IRC server, the client B requests the same Web document as that requested by the client A from the Web server (S508).

In other words, upon receiving the Web document request control message transferred from the IRC server, the client B provides the received control message to a message analyzer in its collaborative browsing component program.

The message analyzer analyzes the control message transferred from the IRC server to determine the type of the event having occurred, and then provides the analyzed event contents to a message processor.

The message processor applies a command for execution of the event contents, or the Web document request, provided by the message analyzer to a Web browser of the client B to instruct the browser to request the Web document from the Web server.

As a result, the Web server searches for the Web document requested by the client B and provides it to the client B (S509). It should be noted here that the Web document requested by the client B is the same as that requested by the client A.

In this manner, all events are synchronized between the Web browsers run in the remote user terminals. Of course, other events can also be synchronized in the same manner as the above. For example, in the case where the client A scrolls a Web page, namely, where a scroll event occurs (S510), a control message corresponding to the scroll event is sent to the IRC server (S511).

Upon receiving the scroll event control message sent from the client A, the IRC server transfers the received control message to the client B participating in the same session (S512), thereby causing the Web page scroll to occur in the client B synchronously with that in the client A (S513). In the present embodiment, other events may be a mouse event, keyboard event and so forth. In the mouse event, when a picture is drawn on a Web browser of a collaborative browsing component client, the same picture can also be displayed on Web pages of other clients participating in the same session. In the keyboard event, when a collaborative browsing component client gains access to a Web site and fills out a member registration sheet with his/her personal information in words to register himself/herself as a member of the Web site, the same page written with the personal information can also be displayed on other clients participating in the same session.

Summarizing the above-described IRC protocol-based Web collaborative browsing method in accordance with the present invention, first, the client A opens a collaborative browsing session.

After the collaborative browsing session is opened by the client A, the client B participates in the opened session. If the client A accesses a Web server and conducts Web surfing, then a control message corresponding to such an event (Web surfing) is sent to an IRC server. At this time, the Web server sends to the client A a Web document on which the client A surfs.

The IRC server transfers the event control message directly to the session participant, or client B. In response to the transferred control message, the collaborative browsing component program of the client B instructs the Web browser to request the same Web document from the Web server and download the contents thereof from the Web server. Note that the Web server sends the same Web document to both the client A and client B. Consequently, it can be seen from this fact that the client A and the client B are in synchronization with each other.

As apparent from the above description, according to the present invention, a plurality of users can view a Web page of the same address, or uniform resource locator (URL), at the same time through Web browsers run in a plurality of terminals. The users act as clients to an IRC server by means of collaborative browsing client programs installed in the Web browsers.

On the basis of these component programs, the users can each construct a desired session or join a pre-constructed session to share the same Web page with other users in the same session. Each of the collaborative browsing client programs is executed in the corresponding Web browser to act to receive an event from the Web browser, create a message corresponding to the received event and send the created message, and to receive a message from the IRC server, analyze the received message and apply a command based on the analysis result to the Web browser. Therefore, using an existing standard IRC server, synchronization can be established among browsers of a plurality of users in one session. The component program used herein can automatically be downloaded over the Web.

Generally, an Internet user cannot share Internet searching activities with other Internet users in real time. That is, while conducting Web surfing, an expert cannot provide information to other remote users. A collaborative browsing method has been proposed in order to solve this problem, but it has a difficulty in installing a client program or the inconvenience of having to implement a new server as a collaborative browsing server. However, the present invention provides a Web collaborative browsing system and method using an IRC protocol, wherein a client program is implemented with Java applet or ActiveX so that it can be automatically downloaded and installed from a Web server, and a standard IRC server is used to transfer a control message, thereby enabling a plurality of users to readily perform Web searching collaboratively. Furthermore, the present system and method can analyze/process not all events of an OS level, but only events occurring in a Web browser by means of a component program of an application level. By defining control messages corresponding to such events, synchronization can be established with respect to a variety of events, such as a scroll, etc., as well as a Web page address event.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A Web collaborative browsing method using an Internet relay chat (IRC) protocol and a standard IRC server, comprising the steps of:
a), by a collaborative browsing client, opening a collaborative browsing session;
b), by said collaborative browsing client, creating a control message corresponding to an event if the event occurs while said client is connected to a Web server to conduct Web surfing, after said collaborative browsing session is opened, and then sending the created control message to said IRC server over a network;
c), by said IRC server, receiving the sent event occurrence control message and transferring the received control message to a plurality of clients participating in said collaborative browsing session opened by said collaborative browsing client; and
d), by a collaborative browsing component program of each of said session participating clients, instructing a Web browser of a corresponding one of said session participating clients in response to said control message to request the same event as that having occurred in said collaborative browsing client, from said Web server.

2. The Web collaborative browsing method as set forth in claim 1, wherein said step b) includes the steps of:
b-1) detecting said event if it occurs in a Web browser of said collaborative browsing client while said collaborative browsing client is connected to said Web server via said Web browser thereof to conduct the Web surfing;
b-2) analyzing the contents of the detected event;
b-3) creating said control message corresponding to the analyzed event contents; and
b-4) sending the created control message to said IRC server over said network.

3. The Web collaborative browsing method as set forth in claim 1, wherein said network is a wired or wireless network.

4. The Web collaborative browsing method as set forth in claim 1, wherein said step d) includes the steps of:
d-1) receiving said control message from said IRC server;
d-2) analyzing the received control message to determine a type of said event having occurred in said collaborative browsing client; and
d-3) applying a command based on the determination result to said Web browser of said corresponding session participating client to instruct it to request the same event as that having occurred in said collaborative browsing client, from said Web server.

5. The Web collaborative browsing method as set forth in claim 1, wherein said collaborative browsing component program is implemented with at least one of Java applet and ActiveX.

6. The Web collaborative browsing method as set forth in claim 1, wherein said event includes at least one of a Web document request event, a Web page scroll event, a mouse event and a keyboard event.

7. A Web collaborative browsing system using an Internet relay chat (IRC) protocol and a standard IRC server, comprising:
event occurrence processing means for creating a control message corresponding to a type of an event if the event occurs in a Web browser of a collaborative browsing client while said client is connected to a Web server via said Web browser to conduct Web surfing, and then sending the created control message to said IRC server according to said IRC protocol; and
event synchronization means for receiving said control message via said IRC server and instructing a corresponding Web browser in response to the received control message to request the same event as that having occurred in said collaborative browsing client, from said Web server.

8. The Web collaborative browsing system as set forth in claim 7, wherein said event occurrence processing means includes:
an event occurrence detector for detecting said event if it occurs in said Web browser of said collaborative browsing client while said client is connected to said Web server via said Web browser thereof to conduct the Web surfing;
an event analyzer for analyzing the contents of the detected event to determine the type of said event; and
a message sender for creating said control message corresponding to the analyzed event contents and sending the created control message to said IRC server according to said IRC protocol.

9. The Web collaborative browsing system as set forth in claim 7, wherein said event synchronization means includes:
a message receiver for receiving said control message from said IRC server;
a message analyzer for analyzing the received control message to determine the type of said event having occurred in said collaborative browsing client; and
an event requester for applying a command based on the determination result to said corresponding Web browser to instruct it to request the same event as that having occurred in said collaborative browsing client, from said Web server.

10. The Web collaborative browsing system as set forth in claim 7, wherein said event includes at least one of a Web document request event, a Web page scroll event, a mouse event and a keyboard event.

11. A digital processor-readable storage medium for storing a program typically composed of commands executable by a digital processor to perform a Web collaborative browsing method using a standard Internet relay chat (IRC) protocol, said program being configured to perform the steps of:
a), by a collaborative browsing client, opening a collaborative browsing session;
b), by said collaborative browsing client, creating a control message corresponding to an event if the event occurs while said client is connected to a Web server to conduct Web surfing, after said collaborative browsing session is opened, and then sending the created control message to an IRC server over a network;
c), by said IRC server, receiving the sent event occurrence control message and transferring the received control message to a plurality of clients participating in said collaborative browsing session opened by said collaborative browsing client; and
d), by a collaborative browsing component program of each of said session participating clients, instructing a Web browser of a corresponding one of said session participating clients in response to said control message to request the same event as that having occurred in said collaborative browsing client, from said Web server.
